(19) United States
(12) Patent Application Publication
(10) Pub. No.: US 2008/0114748 A1
(43) Pub. Date: May 15, 2008

(54) PEER REVIEW SYSTEM AND METHOD THEREFOR

(76) Inventor: Richard Varner, Peoria, AZ (US)

Correspondence Address: WEISS & MOY PC, 4204 NORTH BROWN AVENUE, SCOTTSDALE, AZ, 85251, US

(21) Appl. No.: 11/559,161

(22) Filed: Nov. 13, 2006

(51) Int. Cl. G06F 17/30; G06F 7/00

(52) U.S. Cl. 707/5; 707/102; 707/E17.059; 707/E17.06

(57) ABSTRACT

A computer server hosting a website wherein the computer server executes program instructions, the programming instructions comprising: authenticating a valid customer; entering survey data and comments about a service provider by the valid customer from a computer system coupled to the server; adding survey score and comments to a database of the service provider; post survey score and comments on the website; filtering survey data and comments for triggers indicating potential liability for the service provider; and notifying the service provider of the potential liability.

### FIELD OF THE INVENTION

The present invention relates generally to a peer review system, and more specifically, an improved system and method to accept, store, and retrieve autonomous internet user submitted product and/or service reviews solicited by the product and/or service provider and facilitate communication between the submitter, the product and/or service provider, and internet users.

### BACKGROUND OF THE INVENTION

Presently, many individuals use the Internet to perform research on different products, services, facilities, and the like. Numerous websites have been created to allow buyers and users to research, write reviews and rate the different products, services, facilities. This is especially true in the travel industry.

Today's hotelier is faced with a recent phenomenon brought on by the Internet and the public's embrace of its use for travel research. Many travel sites, including all of the top tier travel sites solicit peer reviews from their customers and the guests of their websites. In addition to these third party travel reseller sites, there are numerous sites whose primary theme is relating traveler's reviews and experiences. The peer reviews are posted on the travel websites for perusal by the Internet surfing public.

Travelers using the Internet to research and/or reserve travel increasingly are becoming aware of peer reviews. The impact of peer reviews is progressively more influential in the booking decision, whether accomplished on or off-line.

The problem with these types of websites is that most reviews are published unverified and unedited. One recent survey indicates that more than sixty percent (60%) of these reviewers indicate mild to severe dissatisfaction with their stay. Because of the viral nature of the Internet, a review posted at a peer review website may appear at a search engine website and many other travel sites, in some cases extending to thousands of travel and hotel booking sites.

Hoteliers are faced with a dilemma. While their desire is to improve customer satisfaction and reputation in the marketplace they have virtually no control over the content of peer reviews, or the ability to respond to them especially at the point when the traveler is making their booking decision. Because most peer reviews are not verified it is possible for the hotel itself to post favorable reviews of their own property masquerading as previous guests. It also is possible for the hotel's competitors to post unfavorable reviews. Additionally, someone who never even has stayed at the property may post reviews. Neither the website owner nor the public can discern which reviews may be fact or fiction. Often, aggravated guests will embellish their reviews far beyond their real experience as revenge against the hotel operator.

While the hotel may in reality experience a high level of customer satisfaction, a couple of scathing reviews on the Internet can result in a substantial amount of lost bookings, revenue, and reputation. If, in fact, the reviews are legitimate, the hotelier has no method to follow-up with the dissatisfied guest, attempt to resolve any concerns, and let the general Internet public know what actions have been taken to remedy the concerns. Even the most prolific of peer review sites has at best a handful of reviews on a specific property, despite the fact that hundreds of guests stay at the property every week. In general, the reviews that are found on the Internet do not give a true, weighted view of the customer satisfaction with a particular hotel. There is insufficient critical mass of data to arrive at an accurate estimate of customer satisfaction.

Hoteliers could host their own peer review section within the hotel's website, follow-up with their past guests and attempt to resolve problems. However, this does not address the problem of the Internet postings at travel sites. Also, reviews posted at the hotel's branded website would be perceived by the public as being biased and therefore transfer little credibility.

Therefore, it would be desirable to provide a system and method to overcome the above problem. The system and method would ensure that peer reviews are legitimate, the hotelier has a method to follow-up with and uniquely identify a dissatisfied guest, attempt to resolve any concerns, and let the general Internet public know what actions have been taken to remedy the concerns.

### SUMMARY OF THE INVENTION

In accordance with one embodiment of the present invention, a computer server hosting a website wherein the computer server executes program instructions, the programming instructions comprising: authenticating a valid customer; entering survey data and comments about a service provider by the valid customer from a computer system coupled to the server; adding survey score and comments to a database of the service provider; post survey score and comments on the website; filtering survey data and comments for triggers indicating potential liability for the service provider; and notifying the service provider of the potential liability.

In accordance with another embodiment of the present invention, a method to accept, store, and retrieve service provider solicited user submitted reviews and facilitate communication between the submitter and service/product provider is disclosed. The method comprises: establishing an independent third party website; entering survey data and comments about the service/product provider by the service provider solicited customer on the website; filtering survey data and comments for triggers indicating potential liability for the service provider; notifying the service provider of the potential liability; and providing a response from the service provider about the potential liability if desired.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is a simplified functional block diagram of the system of the present invention.

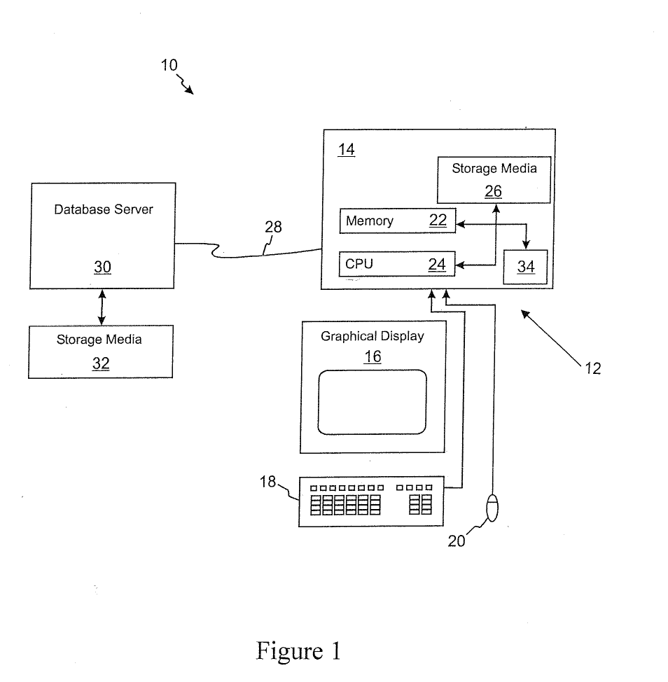

FIG. 2 is a sample picture of the website forming part of the present invention.

FIG. 3 is a sample picture of a second page from the website of the present invention.

FIG. 4 is a simplified flow chart depicting the method of the present invention.

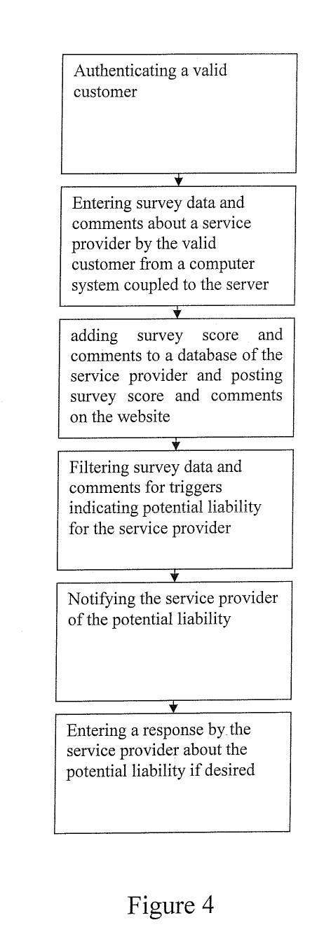

### DESCRIPTION OF PREFFERED EMBODIMENT

Referring to the Figures, an improved peer review system 10 and method will be disclosed. The system 10 allows a computer system 12 to access a server 30 which host a third party independent website. While the description below is in reference to a travel/hotel review system, the system 10 may be used for any type of product and/or service review in order to facilitate communication between the submitter, the product and/or service provider, and internet user.

The website will have hotel review information and accurate rating of hotel guest satisfaction. The website will not be affiliated with any hotel, airline, travel service, and the like. The computer system 12 will have a processor unit 14 and a display 16. The processor unit 14 will generally have a central processing unit (CPU) 24, memory, 22 and a storage media 26. Input devices are coupled to the processor unit 14. The input devices may be a keyboard 18, a mouse 20 and the like. The input devices will allow a user to input information for searching the website and for adding information to the website.

The computer system 12 may access the website via a connection 28. The connection 28 may be a wired connection, a wireless connection or the like. The connection 28 may be part of a network such as a local-area network (LAN), wide-area network (WAN), the Internet or the like.

Through the execution of program instructions forming a computer program product within the server 30, the computer system 12 will provide a means to accept, store, and retrieve internet user submitted hotel reviews and facilitate communication between the submitter, the hotel provider, and internet users. Any data stored from the running of the program instructions such may be stored entirely within a storage media 32.

The website hosted on the server 30 will be a third party independent website. The website will not be affiliated with any hotel, airline, travel service, and the like. The website will be perceived by the Internet public as the definitive resource for hotel review information and accurate rating of hotel guest satisfaction.

The website will work in the following manner. Hotels will have to sign-up with the website. As a participant, the hotel would request all guests (upon completion of their stay) to complete a customer satisfaction survey conducted by the website. The customer will be informed that the website will be an independent third party website not affiliated with the hotel.

Upon completion of the stay, the hotel sends the guest a request, via email, regular mail, during checkout, or the like to provide a review of their stay at the hotel. The request will contain a way to uniquely identify the customer while allowing the customer to remain autonomous to the website. For example, the request to fill in a survey may contain a URL link to the website. The link is encoded with unique parameters enabling the website to identify the participating hotel. The parameters also enable the hotel to identify the guest. By identifying the guest, the hotel can also identify the dates of stay and room occupied.

As an example, the URL may be as follows: http://www.guestremarks.com/bbbb/xxxx/yyyy/051706/review.html In this example, bbbb could refer to a specific hotel brand, xxxx could refer to the hotel property's unique location identifier, yyyy could refer to the reservation confirmation code, and 051706 could refer to the date of request.

Alternatively, the hotel could furnish the customer with a URL that would direct them to the website which will host an online survey. When the customer goes to the website, the website will prompt the user to a unique identification number/password which the hotel will provide to the customer to uniquely identify the hotel and customer. The website can then validate this information.

Once the authenticity of the customer is validated, the past guest will be able to complete a review wherein they rate and provide comments regarding their stay at the hotel. Reviews would expand or contract based on the property and the guests' answers to survey questions. For example, if the past guest gave a poor review of the room service, additional questions may be asked as to the problem. As the past guest completes the survey, individual questions would be validated for format, and rejected for inappropriate language by the operators of the website.

Operator's of the website would parse these parameters when the guest submits a review. If the hotel property's unique identifier were not valid the reviewer would not be authorized to post a review. Time constraints also could be used in the acceptance of a review. Additional parameters could enable further functionality. These parameters would allow the website to validate the authenticity of a review.

Upon completion of the survey the review would be added as a new record to one or more databases and then select information would post to the Internet. The survey record would be filtered for triggers that indicate potential liability for the hotel. If the survey generates a trigger the hotel is notified immediately. The hotel may be notified by phone, email, or the like. This enables the hotel to do damage control by responding immediately to negative reviews. The notification would contain unique parameters allowing the hotel to identify the guest. After identifying the guest, the hotel also would be able to establish their dates of stay and room occupied, plus all contact information from data maintained in the hotel's own records. A URL would be included in the notification (with parameters similar to those referenced in the guest's email above) enabling the hotel to respond to the guest's remarks. The hotel's response would be posted on the website and append to the reviewer's remarks. This enables the hotel to respond immediately to negative reviews on and offline. The guest and hotel could have an ongoing dialogue regarding the reconciliation of the guest's concerns, with that dialogue posted to the website.

As multiple reviews are submitted for a unique hotel property, sufficient data would be compiled to affect weighted rankings for various aspects of the hotel operations and guests' remarks. Review surveys could include, but not be limited to the following:

Quantitative (rated on a scale of 1 to 5 with 5 being great and 1 being poor):

Price

Cleanliness

check-in/check-out process

housekeeping

room service

grounds

pool area

exercise room

complimentary breakfast

room size

bed quality

amenities

appearance

quietness

responsiveness of staff

parking

location

shuttle service

Subjective:

Would you recommend this hotel?

Would you stay at this hotel again?

What is the best aspect of this hotel?

What areas need improvement?

Other remarks and comments

As part of the review survey, the reviewer will be requested to indicate a group with which they most closely identify, or create their own grouping. An example of different types of groups might be:

handicapped individuals

business travelers

guests with children

guests with pets

honeymooners

group travel, etc.

This allows for reviews to be analyzed by subsets based on user groups. It should be noted that the above list of groups is given as an example and should not be seen as to limit the scope of the present invention.

As an example, a single property quickly could amass over 1,000 reviews, and a small city with 15-20 properties could accumulate 10,000-20,000 hotel reviews. A person with disabilities might be most interested in reviews from the city's subject hotels where the reviewer was grouped as “disabled”. This would allow the user to compare the reviews of other “disabled” guests quickly and easily, thus presenting more refined and salient review data to the user.

The reviewers may further be solicited to offer a narrative review of their stay and a numerically rated review of the city. For example, using a 1-5 scale rating, the user may rate different city amenities such as dining, entertainment, activities, traffic, shopping, and the like. Reviewers would be encouraged to provide photographs and videos supporting their reviews.

The previously described reviewer groups would enable a user to refine city/area reviews by common interest. As an example; a person could find those things in common among the reviews of the city/area authored by the “retiree” group. As experiences are shared and critical mass is attained, a common thread of experiences would surface offering valuable insight and resources to the retired user.

As critical mass of reviews is achieved for each participating hotel property, a variety of comparative graphs and tables would become available. These graphs and tables would be derived from the hotel reviews and would depict the following types of data, available to both the public and the hotelier:
1. User Rating Over Time—Depicts the trend of customer satisfaction with the hotel. Numeric rating generated by all customers for the past month, year, etc.
2. Competitor Analysis—Depicts overlay of multiple hotels' ratings
3. Market Analysis—Depicts the hotel's rating in relation to its geographic market
4. Class Analysis—Depicts the hotel's rating in relation to its class of property (i.e. Luxury, Budget, Extended Stay. Etc.)
5. Brand Analysis—Depicts the hotel's rating in relation to a brand's overall ratings
6. Word Charting—Depicts the frequency of words contained in a review and the change over time
   Each of these graphs/tables could be isolated into subcategories, such as Check-in/Check-out Process, Housekeeping, Customer Service, Cleanliness, Comfort, Room Size, Grounds, Parking, etc. Each of the graphs/tables can be refined further to display data from unique user groups (i.e. reviews submitted by: handicapped individuals, business travelers, guests with children, guests with pets, honeymooners, group travel, etc.)

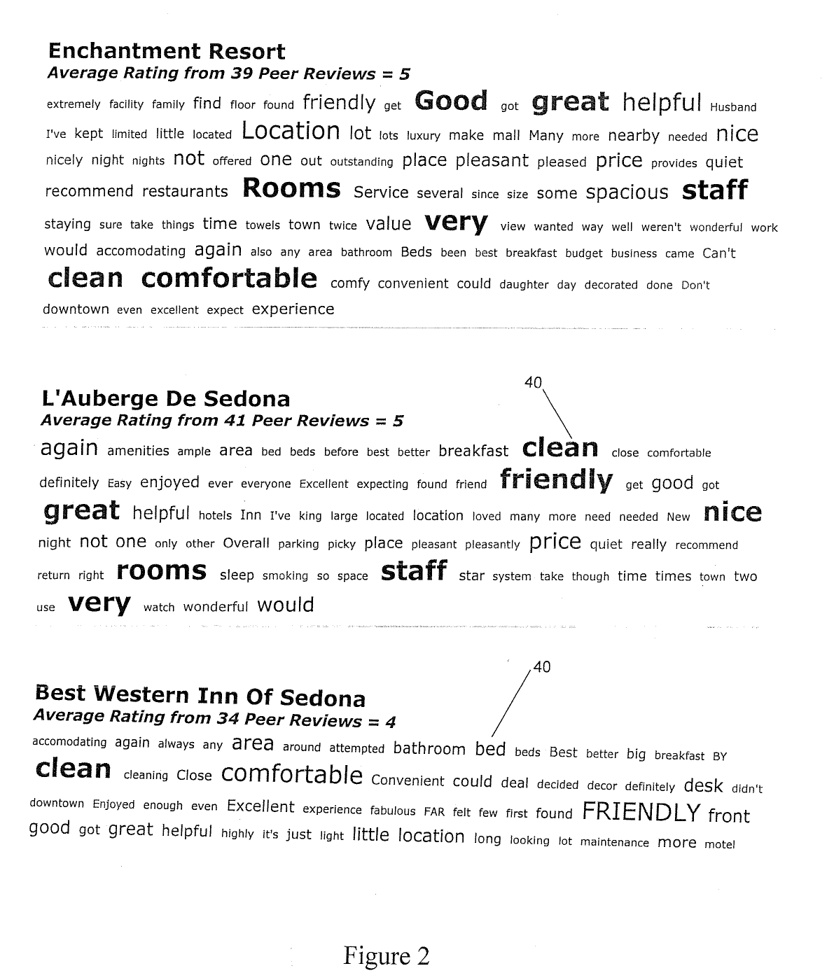

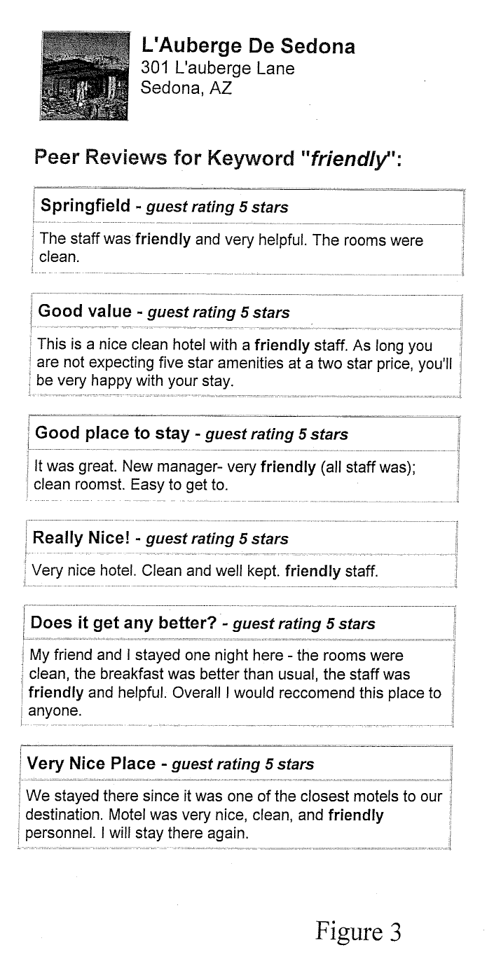

Referring to FIG. 2, an example of the word charting function of the website is shown. As stated above, word charting depicts the frequency of words contained in a review. For each hotel, certain key words 40 are displayed. The key words 40 that appear the most times are shown in a larger font 42. Positive key words may be displayed in a particular color or font while negative key words may be displayed in another color or font. When a customer clicks on a specific key word 40 under a specific hotel, the user will be sent to another webpage. That webpage will list all the reviews for that specific hotel that lists the specific key word that was clicked. For example, if the user clicks on the key word “friendly” for the L'Auberge De Sedona, the user will be sent to another webpage as shown in FIG. 3 that has all the reviews for the L'Auberge De Sedona having the word “friendly” in the written review.

The website will allow reviewers to create a personal profile. This profile would enable reviewers to be linked uniquely to all their submitted reviews. As users read reviews they would be encouraged to rate the usefulness of the review on a numeric scale. This would allow for the comparative ranking of usefulness of reviews (i.e. a user could retrieve the top 10 reviews ranked by other users as being most useful on a particular hotel). This also would allow for reviewers to be ranked based on the public's perception of the usefulness of their reviews. Reviewer authority could be developed (i.e. a reviewer is ranked as being the authority on luxury hotels, or on San Diego hotels, or on handicapped accessibility, etc.).

Quantitative data would be scored, weighted, and averaged, to generate numerical rankings. Subjective data would be filtered to spot trends or threads of common data. The data would be segmented by date to provide trends in ranking and subjective data. The summary of the quantitative and subjective data would be posted on the website in table, graphical, and text format. Data may be licensed for use by the hotel and other online and offline publishers.

The website may establish common threads among users and chart the common threads. Examples could be as follows:
1. The hotel most commonly also reviewed by the reviewers of the Fairmont Scottsdale Princess Resort is the Four Seasons San Diego.
2. The Ritz-Carlton Chain has more reviews authored by golfers than any other chain.
3. The Blue Iguana Restaurant is referenced most by Sedona reviews.
4. Surfing is the most popular activity based on reviews from guests of the Best Western Island Palms.
5. The 5 Washington hotels reviewed most by honeymooners

### The above is given as an example and should not be seen as to limit the scope of the present invention.

The website will allow users to enroll in a delivery system whereby content would be delivered to the user as it is added to the website. The schedule of delivery and filters would be set by the user. For example:
1. Users getting married in 5 months plan to honeymoon in Maui, Hi. They enroll in a user notification to send them weekly via email all reviews submitted for hotels and city/area in Maui by reviewers who are in the honeymoon category.
2. A user has a trip planned to Circus Circus Hotel in Reno, Nev. in 2 months and enrolls to receive via RSS Feed all user reviews as submitted that rate the hotel as poor.
3. An elderly user is planning a trip to Chicago next year and enrolls to receive via email monthly all city/area reviews for Chicago submitted by the “Retired” group that reference golf.

### Again, the above are given as examples and should not be seen as to limit the scope of the present invention.

The website will allow users to search for reviews of participating hotels in a specific area. The user may select the desired search preferences: ammenitites, room service, pool area, exercise room, complimentary breakfast, room size, parking, location, shuttle service, and the like. It should be noted that the above listing is given as an example and should not be seen as to limit the scope of the present invention. A list of the hotels matching the desired search preferences will appear.

As a participant in the website, the hotel would be furnished with secure access to all customer reviews and encouraged to interact with those reviews. The hotel would be able to identify the review to a unique guest thereby enabling them to respond to the individual guests and their concerns, both online and offline. As an example, if the guest complained that the bathtub dripped all night, the hotel would be able to identify the actual room stayed in by the guest and repair the problem, thank the guest for their remarks and make a post to the review site that the problem was resolved. The data would be “real time”, thereby enabling the hotel to respond quickly to reviews and limit their negative impact.

Each participant hotel will receive a CSR—Customer Satisfaction Rating based on the weighted average of guest surveys. The rating may be a numeric value based on the survey. For example, a numeric rating from 0-5 where 5 would be the most favorable rating. Participant hotels would be encouraged to display the CSR and related data on their branded hotel website. Each hotel may be rated in a variety of areas, such as: cleanliness, check-in/check-out process, housekeeping, room service, grounds, etc. The data also would be scored by time, class, market, brand, size, price, and other parameters. The data would be displayed graphically, in tables (with drill-down capability).

Users of the website who have interest in further details on a participant's hotel will be directed to the hotel's website (destination page determined by the participant hotel). These referrals will provide a source of substantial booking traffic to the hotel's own website thereby bypassing 3^{rd} Party Travel Resellers. When the participant hotel's CSR outranks those of competitive properties, the hotel will benefit from a marketing advantage and increased bookings. Additionally, hotels can use the CSR data to understand their property better as it relates to other properties within their brand, geographic market, and class, and also track their performance month-to-month.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A computer server hosting a website wherein the computer server executes program instructions, the programming instructions comprising:
authenticating a valid customer;
entering survey data and comments about a service provider by the valid customer from a computer system coupled to the server;
adding survey score and comments to a database of the service provider;
post survey score and comments on the website;
filtering survey data and comments for triggers indicating potential liability for the service provider; and
notifying the service provider of the potential liability.

2. The program instructions of claim 1 further comprising altering survey questions presented based on survey data entered by the valid customer.

3. The program instructions of claim 1 further comprising entering a response by the service provider about the potential liability.

4. The program instructions of claim 1 further comprising entering data relating to characteristics of the valid customer to identify the valid customer with a particular grouping to allow survey data and comments to be analyzed by subsets based on the particular grouping.

5. The program instructions of claim 1 further comprising entering numerical rating and review data of a city where the service provider is located.

6. The program instructions of claim 1 further comprising showing average survey score for the service provider for a designated time frame.

7. The program instructions of claim 1 further comprising showing average survey score for multiple service providers for a designated time frame.

8. The program instructions of claim 1 further comprising showing average survey score for multiple service providers in a designated area for a designated time frame.

9. The program instructions of claim 1 further comprising word charting the comments about the service provider, wherein at least one of keywords, phrases, or common threads/themes that appear most in the comments are displayed under the service provider.

10. The program instructions of claim 9 wherein the key words that appear most frequently are in larger font.

11. The program instructions of claim 9 further comprising hyperlinking each keyword/phrase/thread/theme displayed wherein a user will be sent to another webpage that has all reviews for a specified service provider listing the keyword/phrase/thread/theme selected.

12. The program instructions of claim 1 further comprising creating personal profiles for the valid customer to enable reviewers to be linked uniquely to all submitted reviews by the valid customer.

13. The program instructions of claim 1 further comprising providing a delivery system whereby content would be delivered to a user as it is added to the website, the schedule of delivery and filters would be defined by the user.

14. A method to accept, store, and retrieve autonomous user submitted reviews solicited by the service provider and facilitate communication between the submitter and service provider comprising:
authenticating a valid customer;
entering survey data and comments about the service provider by the valid customer from a computer system coupled to a server;
adding survey score and comments to a database of the service provider;
post survey score and comments on the website;
filtering survey data and comments for triggers indicating potential liability for the service provider;
notifying the service provider of the potential liability; and
entering a response from the service provider about the potential liability if desired.

15. The program instructions of claim 14 further comprising altering survey questions presented based on survey data entered by the valid customer.

16. The program instructions of claim 14 further comprising entering data relating to characteristics of the valid customer to identify the valid customer with a particular grouping to allow survey data and comments to be analyzed by subsets based on the particular grouping.

17. The program instructions of claim 1 further comprising word charting the comments about the service provider, wherein at least one of key words/phrases/threads/or themes that appear most in the comments are displayed under the service provider.

18. The program instructions of claim 17 further comprising hyperlinking each keyword/phrase/thread/theme displayed wherein a user will be sent to another webpage that has all reviews for a specified service provider listing the keyword/phrase/thread/theme selected.

19. The program instructions of claim 13 further comprising creating personal profiles for the valid customer to enable reviewers to be linked uniquely to all submitted reviews by the valid customer.

20. The program instructions of claim 13 further comprising providing a delivery system whereby content would be delivered to a user as it is added to the website, the schedule of delivery and filters would be defined by the user.

21. A method to accept, store, and retrieve autonomous user submitted reviews solicited by the service provider and facilitate communication between the submitter and service/product provider comprising:
establishing an independent third party website;
entering survey data and comments about the service/product provider by the customer on the website;
filtering survey data and comments for triggers indicating potential liability for the service provider;
notifying the service provider of the potential liability; and
uniquely identifying the customer to the service provider;
providing a response from the service provider about the potential liability if desired.

22. The method of claim 21 further comprising:
adding survey score and comments to a database of the service provider; and
post survey score and comments on the website;

23. The method of claim 21 further comprising:
accepting a customer referral from the service provider;
and uniquely identifying the customer to the service provider.

24. The method of claim 22 further comprising authenticating the valid customer.

25. The program instructions of claim 23 further comprising altering survey questions presented based on survey data entered by the valid customer.

26. The program instructions of claim 23 further comprising entering data relating to characteristics of the valid customer to identify the valid customer with a particular grouping to allow survey data and comments to be analyzed by subsets based on the particular grouping.

27. The program instructions of claim 21 further comprising word charting the comments about the service provider, wherein at least one of key words, phrases, or common threads/themes that appear most in the comments are displayed under the service provider.

28. The program instructions of claim 26 further comprising hyperlinking each keyword/phrase/thread/theme displayed wherein a user will be sent to another webpage that has all reviews for a specified service provider listing the keyword/phrase/thread/theme selected.

29. The program instructions of claim 23 further comprising creating personal profiles for the valid customer to enable reviewers to be linked uniquely to all submitted reviews by the valid customer.
